(19) United States
(12) Patent Application Publication
(10) Pub. No.: US 2006/0106707 A1
(43) Pub. Date: May 18, 2006

(54) Method and system for trading derivatives

(76) Inventors: Rohan Dayanand Shetty, London (GB); Emlyn Edward Scott, London (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/988,431

(22) Filed: Nov. 12, 2004

(51) Int. Cl. G06Q 40/00

(52) U.S. Cl. 705/37

(57) ABSTRACT

A computer-based system provides a synthetic Contract for Difference (CFD) trading exchange that has the ability to link and replicate the order flow of corresponding underlying commodity markets into derivative CFDs and also link and replicate the CFD order flow into the underlying commodity markets in underlying non-derivative form, all in real time. A central processor collects CFD orders from remote members and synthesized orders from a synthesizing unit, reflecting orders from underlying cash commodity markets, and sends member orders to the synthesizing unit for replication onto underlying cash commodity markets. Members of the exchange who enter bids and offers at remote terminals have their orders handled in the central processor that compares and prioritises members' orders, finds matches with other members' orders or synthesized CFD orders and completes the execution of the transaction. Whenever a member's CFD order trades against a synthesized CFD order, an equal and opposite underlying cash commodity transaction is created in the underlying cash commodity market, which ensures that two matched trades, one CFD trade and one underlying cash commodity trade, always pass to the denominated clearing house.

### FIELD OF THE INVENTION

The present invention relates to the trading of derivative financial instruments, particularly but not exclusively to a method and system for trading Contracts for Difference (CFDs) on exchange.

### BACKGROUND OF THE INVENTION

A CFD is an agreement between two parties to exchange in cash, at the close of the contract, the difference between the opening price and the closing price of the contract. A CFD is a mirror image or replica of the spot commodity or index on which it is based. It is essentially a swap of cash flows. In the case of an equity CFD, the purchaser of the CFD gains all the financial rights associated with the purchase of stock such as price movement, dividends, stock splits and so on. In return for this benefit, the purchaser pays a financing cost to the seller representing the overnight interest rate on the notional value of the position. Essentially, this is analogous to borrowing money and using it to purchase stock. CFDs give the owner all the benefits of owning a stock, without having to actually own the stock. CFDs have no expiry and are not deliverable. The settlement amount is the difference between the price at which you bought (sold) the contract and the price at which you sold (bought) it. The difference is either a profit or a loss. A CFD is therefore a derivative instrument that replicates the underlying instrument from which it is derived. For example, the price of a CFD will exactly replicate the price of the cash commodity from which it is derived and the profit or loss will be calculated and collected each day at the closing price of the cash commodity. This is often referred to as marked to market or variation margin. It will usually trade in exactly the same trading units as the cash commodity. This is in contrast to futures or options, which trade in lots representing a multiple of the cash commodity from which it is derived, such as 100 or 1,000 times.

CFDs can also be bought or short sold so users can take advantage of price falls as well as gains and also create sophisticated trades such as long short spreads, where one share is bought while another is sold for the equivalent economic value. Other popular trades involve buying or selling an individual stock and trading the economic equivalent in the relevant index as a general market hedge. Thus CFD users gain access to stock specific movement while insulating themselves from the general rise and fall of the market.

For example, a client who wants to buy 1,000 shares in Microsoft at $30.00 could simply contact his local broker and instruct them to buy 1,000 shares in the underlying cash market. Alternatively, the client could contact a CFD provider and buy 1,000 CFDs on Microsoft at the same, or similar, price of $30.00. The CFD will move exactly in line with the commodity from which it is derived and will settle each day at the same settlement price. For example, if Microsoft stock moves to settle the day at $30.50 the CFD will be marked to market at $30.50 and the buyer will be marked to market credited $0.50 on the 1,000 Microsoft CFDs by the CFD provider. i.e. $500. Similarly, the client could just as easily have short sold 1,000 Microsoft CFDs and would thus be marked to market debited $500 overnight. Like futures and other derivatives, CFDs are highly leveraged products, and offer users the ability to magnify exposure significantly on underlying securities such as stock, commodities, indices and foreign exchange, often simply referred to as ‘underlyings’. Initial margins are paid by CFD users and marked to market payments are made overnight reflecting daily profit or loss movements. The initial margin paid by the CFD user reflects a set percentage of the CFD notional value and protects the provider from most adverse price moves until the next marked to market margin call is made. For example, taking the 1,000 Microsoft purchase above, the cash equity buyer would be required to pay the full notional value of $30,000 to buy the cash stock. The Microsoft buyer using CFDs and a 5% margin offered by the CFD provider would be required to deposit $1,500 as initial margin with the CFD provider for their $30,000 exposure to Microsoft. This leverage characteristic has made CFDs very popular with hedge funds and retail users.

CFD buyers are charged an interest rate known as a cost of carry from CFD providers which is passed to CFD sellers less the providers' spread. For futures and options the cost of carry is implied in the derivatives forward value, with the price of these derivatives reflecting the cost of holding the notional value until expiry. This difference in price between the cash commodity and the futures is known as basis. CFDs are marked to market daily at the same price as the underlying commodity thus giving CFDs a basis of zero. The cost of holding the notional value of the position is charged separately each day to the CFD buyer as a separate amount and paid to the seller.

Because CFDs are a derivative they do not give the buyer any rights, unlike a physical shareholder. The CFD buyer will receive all the economic value of the underlying share such as the price movement, dividend payments, stock splits and so on, but no voting rights are transferred.

When a dividend is paid by a company (i.e. the stock goes ex-dividend), the price of the stock will adjust and fall by the amount of the payment. This price drop will also occur on the price of the CFD. To compensate the buyer for the fall in the CFD price, a manufactured dividend payment reflecting the amount of the dividend is paid from the seller to the buyer.

CFDs were first traded around 1990 in the United Kingdom as a way of allowing clients to receive all the benefits of owning a stock without having to actually own the stock. They were developed as a means to short sell an individual stock position. The CFD market then evolved to include bought positions as well as shorts as CFDs enabled buyers to take leveraged bought positions on individual equities without paying UK stamp duty, as no physical stock changed hands.

In 2000, CFDs were offered via the internet to the UK retail market for the first time and gave retail users their first access to CFDs. They rapidly became popular with retail users as an alternative to trading the cash equity market, as they offered users highly leveraged exposure to the cash market and were not subject to stamp duty. They also allowed users the advantage of being able to short sell the market and thus created a much more flexible tool to the cash market. CFDs are not offered to US customers at this point in time.

CFD providers offer their clients a wide range of CFDs. These usually cover a global range of more than 2,000 stocks across most of the major cash equity markets including the US. Providers also offer CFDs on commodities and foreign exchange and create basket CFDs that reflect a basket of underlying stocks.

Institutions and internet service providers offer CFDs in two major formats. The first is the “brokerage” model whereby CFDs are offered at the same price and liquidity as the underlying cash market and a brokerage is charged on all transactions. The CFD provider upon receiving CFD orders from clients immediately replicates these orders into equivalent cash orders on the underlying cash market. Any client trades are also immediately replicated onto the cash market thus reducing their exposure to almost zero. All CFD moves are exactly offset by the movement in the underlying cash equity market. Thus if the CFD provider is long a CFD position to their clients in a particular stock then the provider short sells the exact equivalent position in the particular stock in the cash equity market. If the stock price were to rise then the profits made on the rise in the CFD position would exactly offset the loss made in the underlying sold stock position. Similarly, any stock price falls would see the CFD losses exactly matched by equity gains in the underlying short sold equity position. This model of perfect hedging has proved the most popular with institutional and internet providers and users.

The second major CFD offering is the “no brokerage” model whereby the CFD provider adds a slight spread on the CFD price over the underlying cash market. This spread generally reflects the amount the brokerage type provider would charge in brokerage to their clients. The no brokerage provider is usually more flexible in their hedging methods and will use a more sophisticated array of products and methodology to manage their exposure. These range from a combination of cash, futures and options both stock specific and index specific. The no brokerage provider will try and reduce the amount of hedging to increase returns by netting all their positions into one single portfolio and hedging the exposure referred to as the main portfolio beta one exposure through index futures, and stock specific risk through stock hedges.

In summary the brokerage type provider will usually exactly mimic all CFD transactions on a transaction by transaction basis into the cash market, while the no brokerage CFD provider will create a portfolio position in CFDs and hedge the whole portfolio across various products and markets.

Neither of these models provide CFD clients with the ability to trade between themselves. All transactions are bilateral between the client and the CFD market maker in the OTC market which leaves the client open to uncompetitive spreads on prices, in the case of the “no brokerage” model, or fees, in the case of both models, usually high cost of carry fees. Both models also usually require the client to transact back through the same institution to reverse and close their positions.

Users are not able to post prices directly to other CFD users in a CFD market place. Finally CFD users cannot trade on exchange and their orders are not anonymous, nor are they protected by the clearing model from a centralised market Clearing House.

### SUMMARY OF THE INVENTION

The present invention aims to address the above limitations.

According to the present invention, there is provided a system for trading derivative financial instruments, each of which corresponds to an underlying financial instrument from which it is derived, the underlying instrument being traded on an underlying exchange, the system comprising a derivative exchange for receiving orders for the derivative instruments and a synthesizing unit for automatically placing corresponding orders for the underlying instruments on the underlying exchange.

The synthesizing unit can be arranged to receive orders for underlying financial instruments from the underlying exchange and to place corresponding orders for the derivative instruments on the derivative exchange.

This allows for a two way flow of orders between the derivative and underlying exchanges.

According to the invention, there is further provided a system for trading derivative financial instruments, each of which corresponds to an underlying financial instrument from which it is derived, the system comprising a derivative exchange for receiving orders for the derivative instruments, an underlying exchange for receiving orders for the underlying instruments and a synthesizing unit linked to the derivative exchange and the underlying exchange, for replicating orders on the derivative exchange onto the underlying exchange and for replicating orders on the underlying exchange onto the derivative exchange.

According to the invention, there is still further provided a system for linking a derivative market and an underlying market, the derivative market for trading derivative financial instruments, and the underlying market for trading underlying financial instruments from which said derivative instruments are derived, the system comprising a synthesizing unit for receiving orders from at least one of said derivative and underlying markets and for generating equal and opposite orders on at least the other of said markets to enable members of said at least one of said markets to trade with members on said at least the other of said markets.

The invention yet further provides a method for trading derivative financial instruments on a derivative exchange, each of the derivative instruments corresponding to an underlying financial instrument from which it is derived, the underlying instrument being traded on an underlying exchange, the method comprising receiving orders for the derivative instruments, receiving orders for the underlying instruments and replicating orders on the derivative exchange onto the underlying exchange and replicating orders on the underlying exchange onto the derivative exchange.

The derivative financial instruments can be Contracts for Difference (CFDs).

Implementations of the invention go beyond simply listing CFDs on exchange, as this does not provide the solution that CFD users desire. Examples of the invention not only provide an exchange model for CFDs but uniquely provide a mechanism whereby CFD users are able to place orders on exchange and have their orders linked and reflected in real time on the underlying cash market, while also seeing the underlying exchange prices and volumes reflected in CFD orders on the CFD exchange, so that CFD users will be assured of receiving the best possible prices and volumes available, which may be from another CFD user or from the underlying cash commodity market. They will also benefit from the anonymity and risk benefits of centralised clearing.

The invention allows client orders to trade freely between themselves and be fully replicated back and forth between the derivative market and the underlying cash market to ensure best price execution.

In one example of the invention, the derivative product can be created separately on the same platform as the cash product, while replicating the prices and liquidity between the derivative product and the cash product. The platform could comprise an exchange or an electronic communication network (ECN). Thus, for example, one exchange runs two markets, one underlying and one CFD based off this underlying, that are linked together within the one entity.

In another example, the derivative product is created on one exchange and the prices and products are linked to the underlying cash product on a separate exchange while still fully replicating prices and volumes back and forth between the derivative and underlying markets.

Embodiments of the invention provide anonymity via the exchange and the novation process with the clearing house, where the clearing house becomes the counterparty to both sides of the CFD transaction providing guarantee of fulfilment. The CFD user no longer has bilateral positions with a particular CFD provider but rather has a novated position with the clearing house insuring that their transactions are no longer at risk of their broker dealer provider defaulting. Further, the exchange model allows the client to open a CFD position with one broker and close their position via another broker.

In summary, examples of the invention provide for a linked synthetic CFD trading exchange that has the ability to replicate the order flow of corresponding underlying commodity markets into derivative CFDs and also replicate the CFD order flow onto the underlying commodity markets in underlying non-derivative form. For the first time a derivatives exchange will allow members to trade CFDs with each other and be completely connected to the price and volume orders of the underlying cash market, and also transfer the prices and volumes of CFD orders onto the cash market. Essentially, this will ensure a derivatives exchange and a cash exchange order and transaction flow are completely intertwined even though the derivative and cash products may be offered on separate exchanges or on the same exchange.

### BRIEF DESCRIPTION OF THE DRAWINGS

Further characteristics, features, and advantages of the present invention will be apparent upon consideration of the following detailed description of the invention, in conjunction with the following drawings, and in which:

FIG. 1 is a block diagram illustrating a standard underlying cash commodity market showing the connection of clients to exchange members to the exchange, followed by a clearing house and central securities depository;

FIG. 2 is a block diagram illustrating the current over-the-counter (OTC) CFD market place, its connection to the underlying cash commodity market exchange, its members and customers;

FIG. 3 is a block diagram illustrating a system according to the present invention;

FIG. 3a shows an example implementation of the system of FIG. 3; FIGS. 4a through 8 are flow diagrams showing processing by the system of FIG. 3. The flow diagrams apply to the processing of underlying cash and CFD orders and transactions. In particular;

FIGS. 4a to 4c illustrate the trading process for the CFD exchange for a limit order;

FIG. 5 illustrates the trading process for the CFD exchange for a market order;

FIG. 6a illustrates in detail the bid matching process shown in FIG. 5;

FIG. 6b illustrates in detail the offer matching process shown in FIG. 5;

FIG. 7 illustrates the replication process carried out by the synthesizing unit; and

FIG. 8 illustrates the limit order cancellation process.

### DETAILED DESCRIPTION

Embodiments of the invention will be described in terms of an automated exchange market for equity Contracts for Difference (CFDs). However, it will be understood that the invention is not limited to equity CFDs and may be applied to other financial instruments such as commodities, foreign exchange, indices, bonds and the like.

The invention will be described in terms of a CFD market for a single equity called ABC stock, which is akin to any share such as Microsoft. It is understood that the CFD exchange according to the invention can simultaneously provide markets in multiple equity stocks across multiple markets and in multiple currencies, as well as multiple markets in multiple other financial instruments.

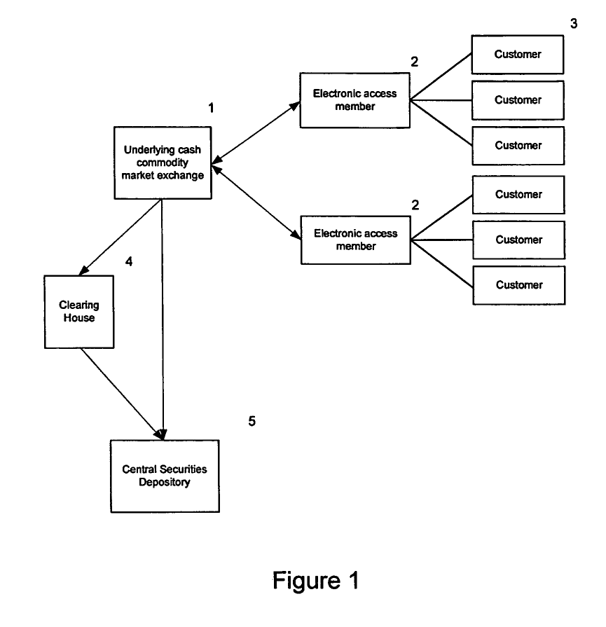

The underlying cash commodity markets described in FIGS. 1 to 3 are usually automated registered exchanges regulated under their respective regulatory bodies, such as NASDAQ, NYSE or the London Stock Exchange, but are not limited to either fully automated central markets such as the NASDAQ and can include Electronic Communication Networks (ECNs) and general marketplaces such as the foreign exchange market.

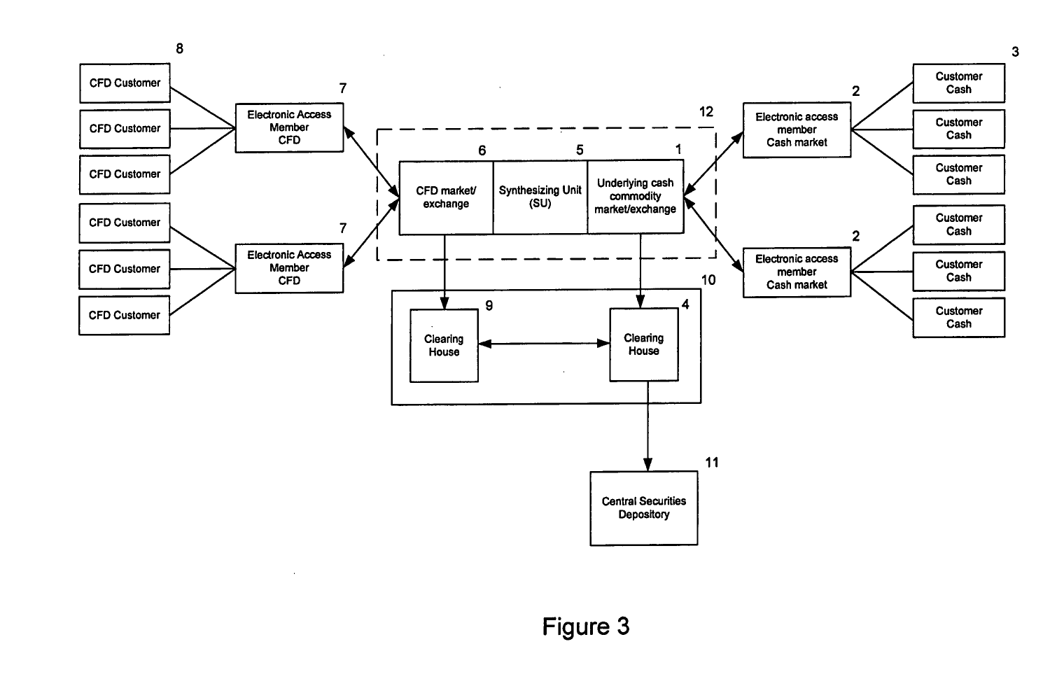

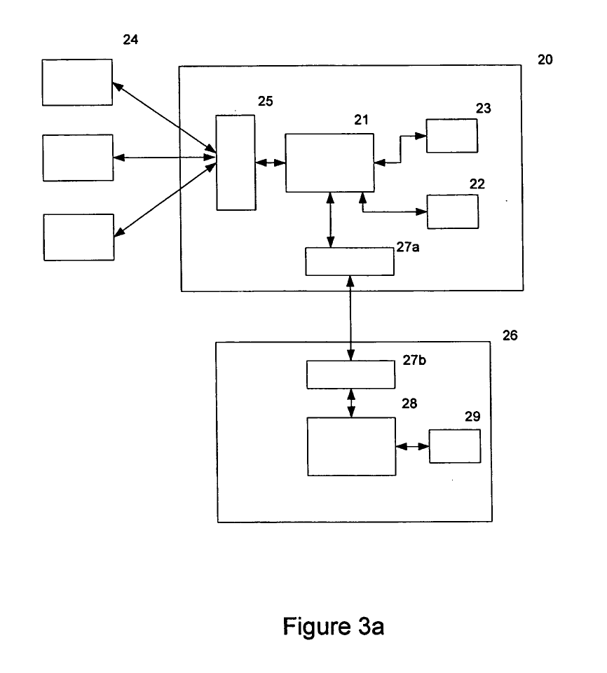

It is understood that names, types and arrangements of participants and orders are used as examples for purposes of illustration and that the arrangement of particular participants and orders may be varied while still remaining within the scope of the invention. One such variation is described in relation to FIG. 3 wherein the CFD market can be a separate exchange connected to the underlying cash commodity market, with one or more synthesizing units connecting the exchanges together, or the CFD and cash commodity can trade on the same exchange, where the CFD and underlying markets are linked via one or more synthesizing units, allowing orders and trades to flow back and forth. For example, the NYSE could list a complete range of CFDs that include both the NYSE's securities and NASDAQ securities. In the case of the NASDAQ list of CFDs, the link would connect two separate exchanges (the NYSE's listed NASDAQ CFD range with the NASDAQ underlying stocks). And in the case of the NYSE's range of NYSE listed CFDs, these would exist on the same exchange (the NYSE) and also be linked via the synthesizing unit to the underlying NYSE stocks. In both instances the synthesizing unit would ensure that all orders are fully reflected between the cash stocks and their corresponding CFDs.

FIG. 1 shows a standard underlying cash commodity market exchange whereby customers 3 instruct buy and sell orders to their brokers 2 who are exchange members. The exchange members in turn pass their clients' orders onto the underlying cash commodity market 1. Transactions that occur on the underlying cash commodity market 1 such as the NYSE are fed through to the designated clearing house 4 such as the National Securities Clearing Corporation (NSCC) for clearing and netting. The clearing house 4 instructs settlement in the Central Securities Depository (CSD) 11 to move securities from the selling broker's account to the NSCC's account then from the NSCC's account to the buying broker's account. Some underlying cash commodity markets, such as the foreign exchange market, do not have a nominated clearing house and trades flow directly from the trading market 1 to the CSD 11.

Orders that are placed on the underlying commodity exchanges can come from many sources such as general public orders, market maker orders and proprietary orders. Order types include limit orders that specify order size and bid and offer price, or market orders which specify an order size but no order price. Bid orders are also interchangeably referred to herein as buy or purchase orders, while offer orders are also interchangeably referred to herein as sell or ask orders.

Further, the underlying cash securities markets and the CFD exchange markets can be quote driven, order driven or combination of the two. Most fixed income markets and NASDAQ are quote driven markets whereby market makers commit themselves to post continuous bid and ask prices for end clients to trade against. Conversely, most equity markets are order driven markets whereby a centralized order book directly matches client buy and sell orders against one another. Thus in quote driven markets market makers provide liquidity, while in order driven markets the end clients provide the liquidity. Hybrid markets combine the two, often with a central market offering the best bid or offer prices whether they are initiated from the end client or the market maker.

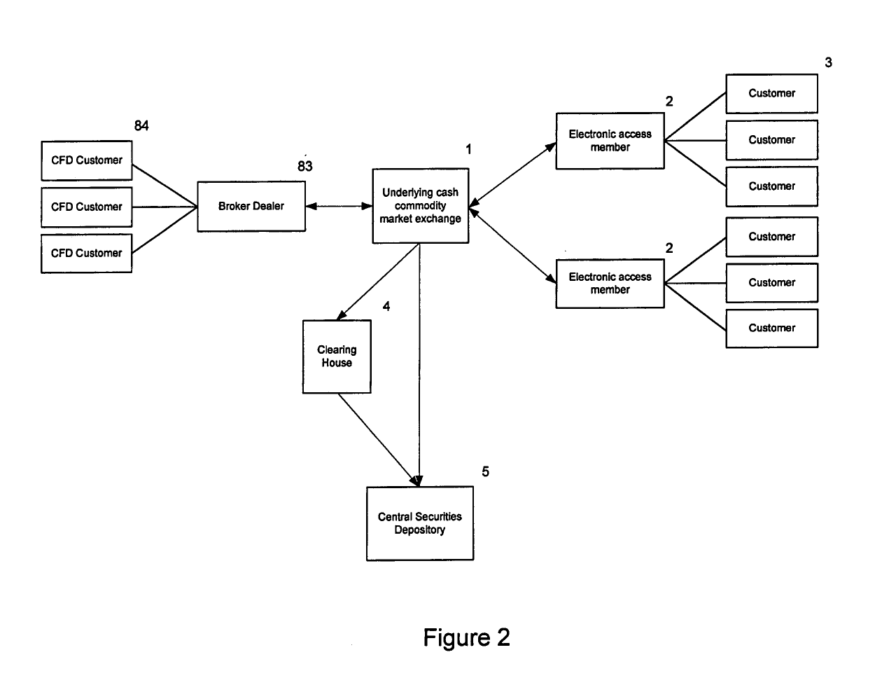

FIG. 2 shows the current ‘brokerage’ CFD OTC market model whereby broker dealers 83 connect as members to the exchange 1. Clients 84 place principal CFD orders with the broker dealers 83 either electronically or via telephone and these OTC traded orders are correspondingly mirrored and hedged as underlying cash commodity trades on the underlying cash market 1. In the case of the ‘no brokerage’ model, the CFD market marker 83 would connect to multiple other markets to hedge the principal CFD trades conducted with their clients.

Table 1 shows an example of a portion of the underlying cash equity market 1 in ABC stock. For example, a total of 10,000 shares have been best bid at $50.00 while 15,000 shares have been best offered at $50.01. The cash market of ABC stock can be fully and exactly replicated by a CFD broker dealer 83.

TABLE 1
ABC stock on underlying cash commodity market

| Bid | Volume | Offer | Volume |
|---|---|---|---|
| 50.00 | 10,000 | 50.01 | 15,000 |
| 49.99 | 25,000 | 50.02 | 10,000 |
| 49.98 | 15,000 | 50.03 | 45,000 |
| 49.97 | 30,000 | 50.04 | 20,000 |

Table 2 shows an example of a portion of the broker dealer market 83 in ABC CFDs offered to its clients 84. Assume client 84 wishes to buy 5,000 ABC CFDs at $50.01, they will purchase the OTC proprietary CFDs from the market maker 83 who sells 5,000 CFDs in ABC stock at $50.01. The client 84 has now bought 5,000 ABC CFDs while the broker dealer has sold 5,000 ABC CFDs, which exactly replicates the economic value of the underlying cash ABC stock.

TABLE 2
ABC CFD offered by broker dealer

| Bid | Volume | Offer | Volume |
|---|---|---|---|
| 50.00 | 10,000 | 50.01 | 15,000 |
| 49.99 | 25,000 | 50.02 | 10,000 |
| 49.98 | 15,000 | 50.03 | 45,000 |
| 49.97 | 30,000 | 50.04 | 20,000 |

The broker dealer that has sold 5,000 ABC CFDs will now hedge its exposure in the underlying cash equity market 1 by buying 5,000 ABC stocks at $50.01 exactly hedging itself. A slight variation in this model is created by automated CFD broker dealers whose system will instruct the buying order in the underlying ABC stock before confirming the CFD trade with its client. That way the CFD provider will be assured of obtaining its hedge before the client side order is booked.

FIG. 3 shows a system according to the current invention, which permits a derivatives exchange to not only fully exactly replicate the orders in price and volume in real time onto the underlying cash exchange but also fully replicate the cash exchange's orders in price and time back onto the derivatives exchange. It means the two markets are fully linked in synchronization with each other and provides the flexibility to have the CFD derivatives listed on a separate linked exchange or on the same exchange as the cash market.

FIG. 3 shows the CFD exchange 6 interconnected via a synthesizing unit (SU) 5 to the underlying cash commodity exchange 1 whereby electronic orders and trades can flow back and forth between the CFD exchange 6 and the underlying cash commodity exchange 1. Effectively this allows clients 8 of the CFD exchange members 7 to either trade CFD orders with other clients 8 on the CFD exchange 6 or with the underlying cash commodity market clients 3 on the underlying cash commodity exchange 1 via the synthesizing unit 5. Although the exchanges are shown primarily separately in FIG. 3, though linked via the synthesizing unit 5, in one variant of the invention also shown in FIG. 3, the CFD market 6 is linked to the cash commodity market 1 via the synthesizing unit, but the CFD and underlying products are traded on a single combined exchange, illustrated in dotted outline 12.

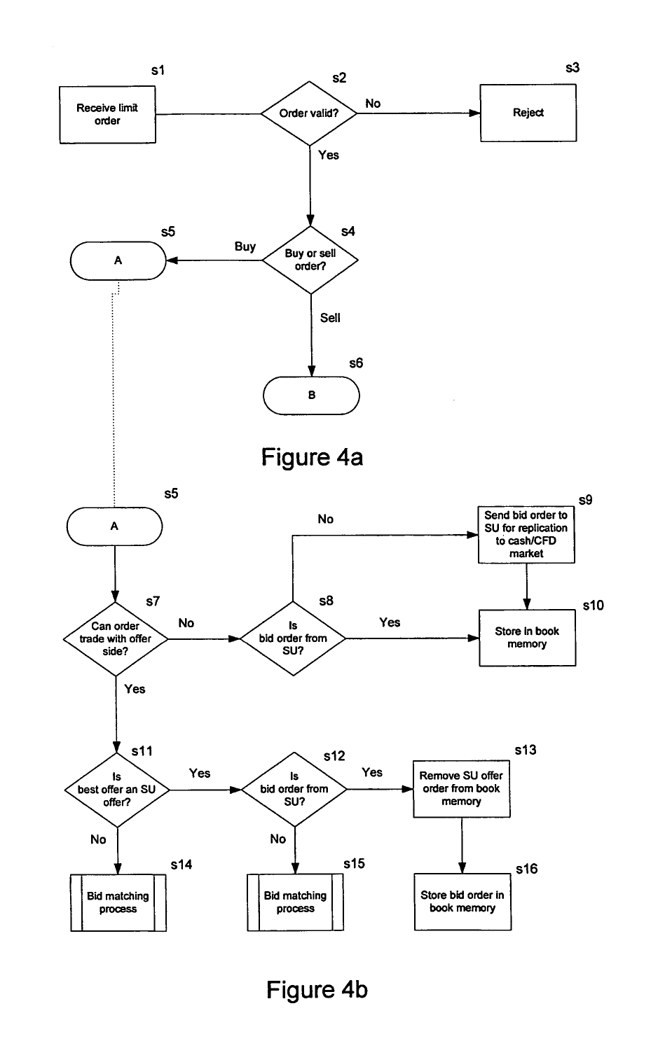

An example implementation of the system of FIG. 3 is shown in FIG. 3a. The cash commodity exchange 1 and CFD exchange 6 are implemented on a server computer 20 operating under the control of a software program. The server computer 20 includes a central processor 21 connected to program memory 22 and book memory 23 which stores buy and sell orders on the exchanges. The program memory 22 stores the software necessary to implement the exchange functionality as described in more detail with reference to FIGS. 4a to 8 below.

The server 20 is connected to client terminals 24, for example terminals operated by the electronic access members 7, via a communications interface 25. The central processor 21 is also connected to a synthesizing unit server computer 26 via communications interfaces 27a, 27b. The synthesizing unit server computer has its own processor 28 and runs software 29 for implementing the synthesizing unit functionality, which is principally the creation of equal and opposite orders and trades in response to orders received by the central processor 21 from the client terminals 24, as well as notification to the central processor 21 when these trades cannot be completed, as will be described in more detail below.

It will be understood by the skilled person that the system described in FIGS. 3 and 3a can be implemented in many different ways, on a general purpose computer or on a network of general purpose computers under software control. The functionality of the synthesizing unit 5 can be implemented on the same server computer 20 as the exchange, on a separate server 26 operated within the exchange, or outsourced to another entity to performing the replicating function. Similarly, the CFD exchange and cash commodity exchange can be implemented on the same server computer 20 or on separate computers linked by the synthesizing unit.

Referring again to FIG. 3, the CFD exchange 6 prioritizes orders on a price time priority basis and has the option to prioritize client orders 8 together with the synthesizing unit's 5 orders or set the synthesizing unit's orders to follow CFD client 8 orders. It is expected that if the CFD and cash stock were listed on the same exchange 12, that no priority to either the CFD or the equity orders would occur, while separately listed and linked exchanges would likely prioritize their CFD orders first.

CFD orders that are traded on the CFD exchange 6 with other CFD customers 8 or with the synthesizing unit 5 are sent to a clearing house 9 for clearing. CFDs are cash margined daily and have no expiry and are closed by effecting an equivalent opposite transaction much like futures before expiry. Because CFDs exactly replicate the economic movement of the underlying cash stock there is the unique ability to exactly match the equity and CFD margin obligations from the CFD designated clearing house 9 with the equity designated clearing house 4 on a portfolio basis. Thus the clearing house 4, 9 will not only be able to add all the bought and sold equity positions together and calculate one margin figure but will also be able to add all the bought and sold CFD trades together with the equity trades. This means that if a member is net long an equity holding in a particular stock and short the CFD in the same stock they would offset or net off against each other reducing the member's risk and margin obligations. The equity and CFD designated clearing houses 4, 9 can be the same clearing house 10 or linked together to create these margin offsetting benefits. This means that hedged CFD positions with their equivalent cash stock would receive little or no initial margin requirements and no variation margin requirements until the underlying stock settles in the CSD 11, often in t+3 or three days after trade. The synthesizing unit 5 would always have exactly matched cash equity trades versus CFD trades on its account. Through the synthesizing unit 5 the underlying cash commodity market 1 can be exactly replicated onto the CFD exchange 6 and vice versa. Assuming initially that

Table 1 reflects the isolated cash equity orders of cash customers 3 in ABC stock and Table 3 below reflects the isolated CFD orders from CFD customers 8 onto the CFD exchange 6 in ABC CFDs.

TABLE 3
ABC CFD on CFD exchange in isolation

| Bid | Volume | Offer | Volume |
|---|---|---|---|
| 50.00 | 5,000 | 50.01 | 10,000 |
| 49.99 | 10,000 | 50.02 | 15,000 |
| 49.98 | 4,000 | 50.03 | 5,000 |
| 49.97 | 15,000 | 50.04 | 3,000 |

Through the synthesizing unit 5 the cash orders in Table 1 for ABC stock could be replicated exactly into CFD orders for ABC CFDs on the CFD exchange 6. Further, the synthesizing unit 5 can also replicate the ABC CFD orders in Table 3 back onto the underlying cash commodity market 1 to fully reflect not only the CFD orders of CFD clients 8 but also their time priority against the cash customers 3.

TABLE 4
ABC CFD on linked CFD exchange

| Bid | Volume | Offer | Volume |
|---|---|---|---|
| 50.00 | 15,000 | 50.01 | 25,000 |
| 49.99 | 35,000 | 50.02 | 25,000 |
| 49.98 | 19,000 | 50.03 | 50,000 |
| 49.97 | 45,000 | 50.04 | 23,000 |

Table 4 above shows the resulting CFD market place for ABC CFDs on the CFD exchange 6. It reflects the addition of the orders placed by CFD customers 8 and the synthesizing unit 5 reflecting exactly the orders from the underlying cash commodity market 1.

TABLE 5
ABC stock on the linked underlying cash commodity market

| Bid | Volume | Offer | Volume |
|---|---|---|---|
| 50.00 | 15,000 | 50.01 | 25,000 |
| 49.99 | 35,000 | 50.02 | 25,000 |
| 49.98 | 19,000 | 50.03 | 50,000 |
| 49.97 | 45,000 | 50.04 | 23,000 |

Table 5 above similarly shows the resulting cash equity market place for ABC stock on the underlying cash commodity market 1. It reflects the addition of the orders placed by CFD customers 8 mirrored via the synthesizing unit 5 reflecting exactly the orders from the CFD exchange 6 plus the orders placed by the underlying cash commodity market customers 3. Both markets show exactly the same liquidity as the other. The net result is that both markets reflect the liquidity of the other market from derivative to cash underlying and vice versa and both markets show exactly the same orders and liquidity. One market is for CFDs and the other is the cash underlying.

This reflection of liquidity onto the CFD exchange 6 from the underlying cash commodity market 1 and from the underlying cash commodity market 1 to the CFD exchange 6, being the addition of the CFD client orders 8 plus underlying cash commodity market client orders 3, can be created on any financial commodity where an underlying market exists such as equities, indices, bonds, commodities and foreign exchange.

However, this is only part of the advantage that embodiments of the invention have over the current model illustrated in FIG. 2. If an order is placed in either the underlying cash commodity market 1 or the CFD market 6 it will be immediately reflected into the corresponding market via the synthesizing unit 5. For example, if a CFD customer 8 wishes to buy 10,000 ABC CFDs at $50.00 the volume bid on the CFD exchange 6 at $50.00 will increase to 25,000. The synthesizing unit will mirror this CFD order onto the underlying cash commodity market 1 as an equity bid for ABC stock for 10,000 increasing the ABC stock bid at $50.00 also to 25,000. This bid on the underlying cash commodity market for cash equities will also reflect the price time priority of the CFD bid onto the underlying cash commodity market 1, thus meaning that if a cash customer 3 or another CFD customer 8 wishes to also buy ABC stock at $50.00 then they will be time prioritized behind the former order. Similarly, if a cash customer 3 or another CFD customer 8 wishes to also sell and trade ABC stock at $50.00 the buyer will be time prioritized behind earlier orders and before new $50.00 ABC bids.

This interaction between the CFD market 6 and the underlying cash commodity market 1 similarly occurs on equity bids or offers by equity customers 3. Thus CFD orders are for the first time reflected back and forth between the underlying cash commodity market and CFD market place, giving both markets full price transparency and reflecting the liquidity from either market onto the other.

Furthermore, just as the orders from the underlying cash commodity market 1 are reflected onto the CFD market 6 via the use of the synthesizing unit 5, and vice versa, so too are transactions.

The system according to the invention allows transactions to flow in both directions between products and market. If for example a CFD customer 8 bid $50.00 for the 5,000 ABC CFDs on the CFD exchange 6 illustrated on Table 3 it would be reflected onto the underlying cash commodity market 1 via the synthesizing unit 5. Assume as well that following this CFD bid on ABC CFDs reflected onto the underlying cash commodity market 1, that an equity customer 3 also places a $50.00 bid for the 10,000 ABC stock as illustrated in Table 1, thus the linking of the two markets would give time priority to the equity customer 3 after the synthesizing unit's 5 bid.

If an equity seller 3 of ABC stock sells 10,000 ABC stock at $50.00 then the synthesizing unit 5 will be time prioritized and purchase 5,000 ABC stock followed by 5,000 of the 10,000 on the bid by the equity customer 3. The synthesizing unit 5 would then sell 5,000 CFDs to the CFD customer 8 who is bidding $50.00 for 5,000 ABC CFDs. The synthesizing unit 5 would be risk neutral as the 5,000 bought ABC stock would exactly match 5,000 sold ABC CFDs. Effectively, the liquidity in each market can be transmitted fully via the creation of these equal and opposite synthesizing unit 5 orders. The system according to the invention allows the CFD customer 8 to reflect their CFD order fully time prioritized and transparently into both the CFD exchange 6 and the underlying cash commodity market 1, allowing them take advantage of whichever marketplace traded at $50.00. Thus for the first time the CFD exchange is effectively linked to the underlying cash exchange for transactions as well as orders.

The CFD transaction would then be sent to the clearing house 9 for validation, novation, margining and risk management. The clearing house would become the counterparty and guarantor of performance to both the CFD customer 8 via their nominated clearing member and to the synthesizing unit 5.

Finally, the system according to the invention also allows CFD customers 8 to trade in a time priority basis with other CFD customer 8 orders. The current market restricts CFD customer 84 orders to transactions with broker dealers 83 on a proprietary basis. This again restricts liquidity and transparency. The system shown in FIG. 3 allows CFD customers 8 to place orders on a time priority basis fully transparent to other CFD participants 8 and to other equity participants 3 via the synthesizing unit 5. Thus a CFD customer 8 can hit the best possible bid or offer in the CFD market which either could be a bid or offer from another CFD customer 8 or an equity customer 3 via the synthesizing unit 5.

Any CFD orders that are matched against other CFD orders do not have the equal and opposite transaction created by the synthesizing unit 5. However, before the match can be registered the corresponding equal and opposite order that is on the underlying cash commodity market 1 by the synthesizing unit 5 must be withdrawn. The flow diagrams in FIGS. 4 to 8 show how this is done to ensure that the synthesizing unit 5 always maintains matched positions and does not trade either a CFD or an equity without the equal and opposite transaction being traded. Following the successful cancellation or adjustment of the synthesizing unit's 5 order in the underlying cash commodity market 1 the matched CFD trade will be registered and sent to the clearing house 9 for clearing.

As explained above, the order processing is carried out on computers underlying the exchanges. CFD orders from remote members are received at the CFD exchange 6 and passed to the synthesizing unit 5. The synthesized CFD orders placed on the CFD exchange 6 reflect orders from the underlying cash commodity markets. Similarly and conversely, the synthesized cash commodity orders placed on the underlying cash commodity market 1 are derived from orders from the CFD exchange 6. Members of the CFD exchange who enter CFD bids and offers at remote terminals will have their orders handled by the central processor that compares and prioritizes members' orders, finds matches with other members' orders or synthesized CFD orders and completes the execution of the transaction. All members' orders can be prioritized over the synthesizing unit orders. The main purpose is to create a central CFD derivative marketplace where members can place large numbers of CFD bids and offers that are transparent to all other members, and through the use of the synthesizing unit, the central marketplace will offer members the same price and volume depth as the underlying cash commodity market so that members can trade CFDs at the best price and volume available whether that be with other members' CFD bids and offers or the synthesizing unit's CFD bids and offers derived from the underlying cash commodity market. However, the invention is not limited to exactly reflecting linked exchange volumes and prices, and encompasses variations that provide small price spreads and limiting volumes.

The exchange will validate whether a member's trade has completed against another member's CFD order or against a synthetically generated CFD order.

Transactions on the CFD exchange can take the following forms:

I. member trades against synthesizing unit;

II. member trades against member; or

III. synthesizing unit trades against member.

Where the first (I) trade type occurs a member's CFD order matches a synthetically generated CFD order from the synthesizing unit. The trade will be held pending on the exchange for confirmation from the synthesizing unit. The exchange informs the synthesizing unit of the matched trade and the synthesizing unit trades an equal and opposite transaction in the underlying commodity in the underlying cash commodity market. Following confirmation from the underlying cash commodity market of the cash transaction, the synthesizing unit 5 confirms its acceptance of the CFD trade to the CFD central processor. The central processor will change the status of the pending CFD trade to accepted, and confirm with the member and the synthesizing unit and send the matched CFD trade to the nominated clearing house for clearing. This is done in real time.

In the case where the second (II) type of order occurs and a member's CFD order matches against another member's CFD order, it will be held pending in the central processor while the synthesizing unit is informed of the trade and makes the corresponding change in the underlying cash commodity market. Once the synthesizing unit confirms the successful change in the underlying cash commodity market, the central processor will change the status of the members' pending CFD trade to accepted, confirm with the two CFD members and send the matched CFD trade to the nominated Clearing House for clearing. This is done all in real time.

Synthesized cash commodity orders generated from CFD member orders can be hit by members of the underlying cash commodity market. The third (III) type of order occurs when the synthesized cash commodity order is hit and traded in the underlying cash commodity market, thus causing the synthesizing unit to place an equal and opposite CFD order to trade on the CFD exchange. The synthesized CFD order trades with the member's CFD order which had generated the cash commodity order that traded on the underlying cash commodity market. Member orders that are hit and traded by the synthesizing unit 5 on the central processor will be instantly accepted and confirmation will be sent to the member and synthesizing unit. The matched trade will be sent to the nominated Clearing House for clearing.

Cancellation of members' bid or offer orders or amendments to orders will also be held pending in the central processor while the synthesizing unit is informed of the order change and makes the corresponding change in the equal and opposite order in the underlying cash commodity market. Once the synthesizing unit confirms the successful change in the underlying cash commodity market the members' bid or offer orders or amendments will be changed by the central processor from pending to active. If however the equal and opposite order is traded in the underlying cash commodity market before the cancellation or amendment can be completed, then the synthesizing unit notifies the central processor of the partial or complete trade and the member is notified that they have completed a part or whole trade before the cancellation or amendment was received and effected.

The synthesizing unit also acts as a real time risk manager. The supply of underlying cash commodities are, in the case of equities for example, limited to the amount of stock on issue. However, the supply of CFD derivatives is theoretically unlimited. Thus if an imbalance begins to occur in a particular stock then the synthesizing unit can restrict the equal and opposite order and transaction flow into and from the underlying cash commodity market to (i) limited long, (ii) long only, (iii) limited short, (iv) short only or (v) disengage the link altogether. This can be conducted on a specific commodity, sector, market or markets. This risk management ability to fully control market linking is in real time and ensures that market integrity is always maintained. Throughout any of these restrictions, CFD members would continue to be able to place orders and trade with other CFD members. Further, normal market controls such as suspending a stock or halting the market as per any normal exchange are also available to the CFD exchange 6.

The present invention is a process by which a derivatives exchange can be inextricably linked to the cash underlying exchange from which the derivatives are derived. For the first time derivative users would be able to trade derivatives on exchange at the full combined liquidity of the derivative orders combined with the cash underlying orders. The CFD users would thus be able to trade at the best price and liquidity possible from the synthetic linking of exchanges and cash and derivative products via the use of a synthesizing unit.

Order Processing

FIGS. 4(a) through 4(c) illustrates the trading process for the CFD exchange 6 or underlying cash market 1 for a limit order, which could be a CFD or an underlying cash order, linked by the synthesizing unit 5. The explanation below is equally applicable for a CFD client entering a CFD order into the CFD exchange 6 and for underlying cash orders entered on the underlying exchange 1 and synthesized onto the CFD exchange via the synthesizing unit 5.

In FIG. 4a an order is received by the CFD exchange 6 from a CFD client 8 via a CFD member 7 or via the synthesizing unit 5 (step s1) and its validity is determined in a conventional way (step s2), for example by determining whether the order identifies a valid product and member. If the incoming order is not valid, it is rejected (step s3) and a rejection message is sent to the CFD member 7 or synthesizing unit 5.

If the order passes validation at step s2, it is then determined whether it is a buy/bid or sell/offer order (step s4). If the order is a buy order it is passed for further processing to a bid order processing routine (step s5), shown in detail in FIG. 4b. If it is a sell order it is passed for further processing to an offer order processing routine (step s6), shown in more detail in FIG. 4c.

FIG. 4b illustrates the processing of a bid order entered onto the CFD exchange 6. The exchange 6 determines whether the entered bid order can trade with the best offer in the exchange at that point in time (step s7). If it cannot trade with the best offer in the exchange, then the exchange 6 determines whether the bid order was placed by the synthesizing unit 5 (step s8). If the buy order is from the synthesizing unit 5, the bid is sent off to the exchange's book memory (step s10) to add to the current bid limit orders in order of time priority. If the bid order is not from the synthesizing unit 5 (step s8) then the bid order is sent to the synthesizing unit (step s9) so that the client order can be replicated by the synthesizing unit onto the underlying cash commodity market 1 as an exact equivalent cash commodity bid limit order. In addition, the bid order is also sent to the exchange's book memory (step s10) for addition to the bid limit orders. It should be noted that this process also applies to a limit equity bid order that can be validated and replicated onto the CFD exchange 6 via the synthesizing unit 5.

If the buy order can trade with the best offer on the exchange (step s7), the exchange determines whether the best offer is from the synthesizing unit 5 (step s11). If the offer order is not from the synthesizing unit then the trade moves directly into the bid matching process (step s14). However, if the best offer is from the synthesizing unit 5 then the exchange determines whether the buy order is also from the synthesizing unit (step s12). If the bid order is also from the synthesizing unit then the synthesizing unit offer order is cancelled (step s13) and the bid order stored into the book memory (step s16). However, if the bid order is not from the synthesizing unit (step s12) then the order moves into the bid matching process (step s15).

FIG. 4c illustrates the processing of an order to sell/offer order entered onto the CFD exchange 6 or cash market 1. The exchange determines whether the entered offer order can trade with the best bid in the exchange at that point in time (step s18). If it cannot trade with the best bid in the exchange, then the exchange determines whether the offer order was placed by the synthesizing unit 5 (step s19). If the offer order is from the synthesizing unit 5, the bid is sent off to the exchange's book memory (step s21) to add to the current offer limit orders in time priority. If the offer order is not from the synthesizing unit 5 then, in addition to being sent to the book memory, the offer order is sent to the synthesizing unit 5, so that the client order can be replicated onto the underlying cash commodity market 1 as an exact equivalent cash commodity offer limit order (step s20).

If the offer order can trade with the best bid on the exchange (step s18) then the exchange determines whether the best bid is from the synthesizing unit 5 (step s22). If the bid order is not from the synthesizing unit 5, then the trade moves directly into the offer matching process (step s25). However, if the best bid is from the synthesizing unit (step s22) then the exchange determines whether the offer order is also from the synthesizing unit 5 (step s23). If the offer order is also from the synthesizing unit 5 then the synthesizing unit bid order is cancelled (step s24) and the bid order stored into the book memory (step s27). However, if the offer order is not from the synthesizing unit (step s23) then the order moves into the offer matching process (step s26).

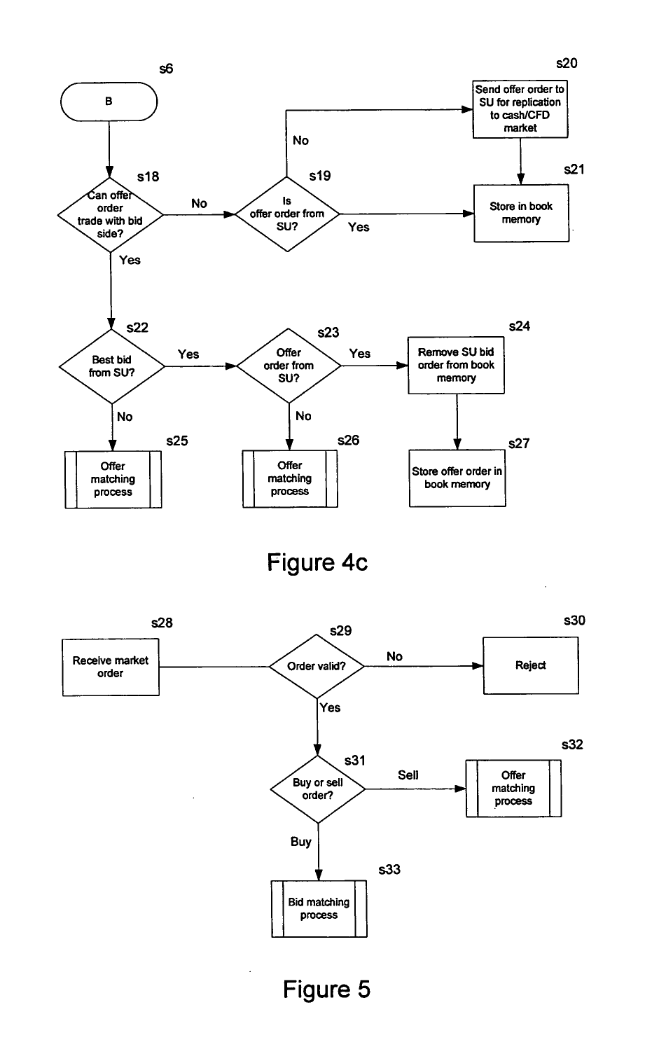

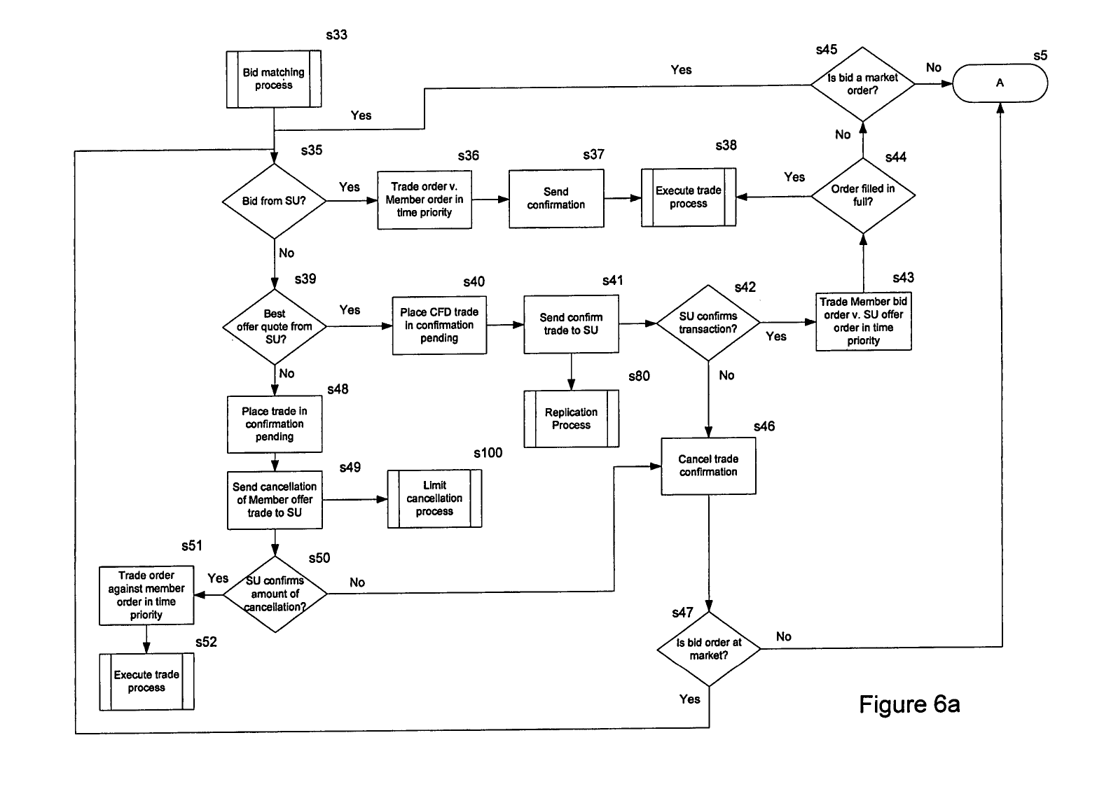

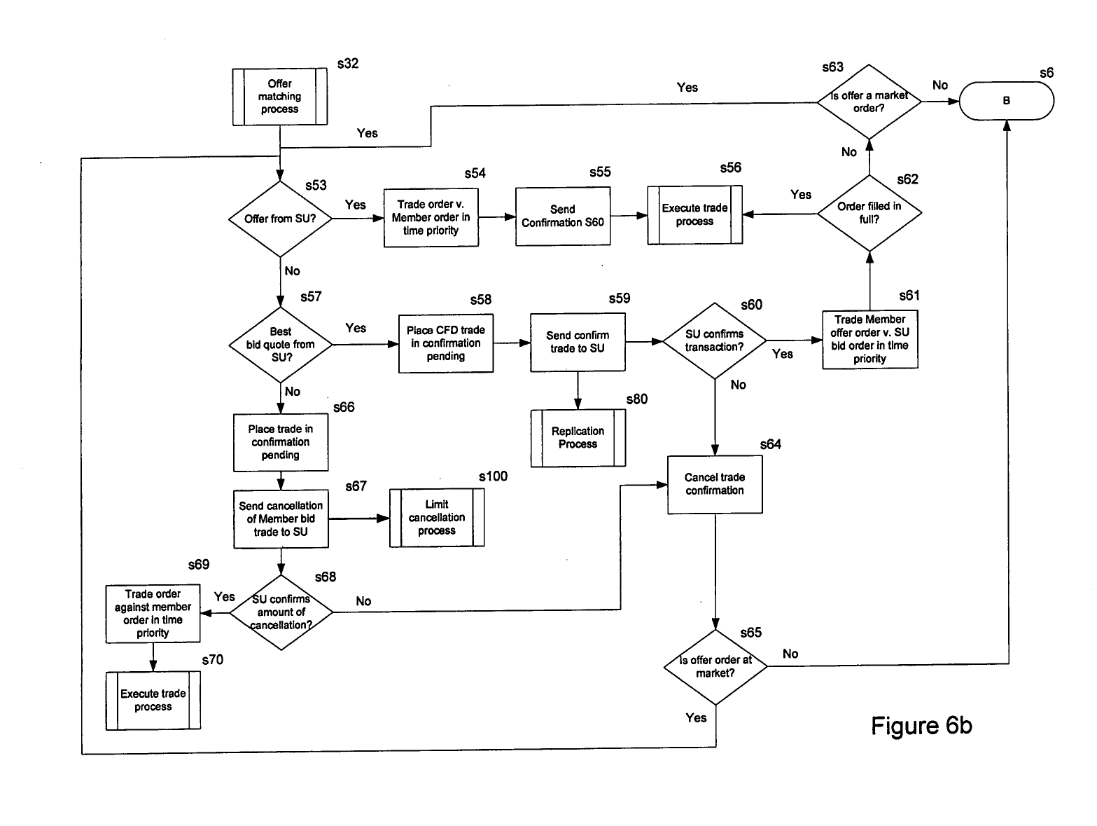

FIG. 5 illustrates the trading process on the CFD exchange for a market order which is an order with a volume but no price limit. The market order is received by the exchange (step s28), which determines whether the order is valid (step s29). If it is not valid, it is rejected (step s30). If the order is valid, then the exchange determines whether the market order is a buy or sell order (step s31). If the market order is a sell order it enters the offer matching process (step s32) and if it is a buy order it enters the bid matching process (step s33). The bid matching process is explained in detail in FIG. 6a, while the offer matching process is explained in detail in FIG. 6b.

Trade Matching

The CFD exchange matches incoming CFD orders against orders received from customers and the synthesizing unit that are in the book memory. The book memory can allow customer orders to have time priority, but not price priority, over synthesizing unit orders if desired. The order processing stage initiates the bid and offer matching process stage which contain steps that ensures that the synthesizing unit always maintains a matched order and trade position between its CFD and equity orders and its CFD and equity trades.

FIG. 6a illustrates the bid matching process and FIG. 6b illustrates the offer matching process. The bid matching process will be described in terms of bid matching examples using Table 4 as the current linked CFD exchange order book and Table 5 as the current linked underlying cash commodity market order book. The following trades are illustrated:

### EXAMPLE 1

Synthesizing Unit Buys 10,000 ABC CFDs From CFD Client

### EXAMPLE 2

CFD Client Buys 30,000 ABC CFDs at $50.01

In FIG. 6a, the bid matching process begins at step s33, where limit and market orders from both clients 8 and the synthesizing unit 5 enter the trading process. The process first determines whether the bid originated from the synthesizing unit 5 or a client 8 (step s35). If the bid originated from the synthesizing unit then the trade moves straight into the trade process (step s36). In example 1, the synthesizing unit buys 10,000 ABC CFDs from a CFD client and the trade process (step s36) trades the synthesizing unit bid against the CFD client sell. If both the CFD exchange 6 and cash exchange 1 for ABC stock is on the same overall exchange 12 a confirmation is then generated (step s37), which is subsequently checked for at step s42. Step s37 is necessary when the CFD market and the cash market are hosted on the same platform 12 as the synthesizing unit's bid had to originate initially from the synthesizing unit's replication order trading in the linked market to initiate the synthesizing unit's bid in this trade. When both markets are on a common platform then the notification for this initial replication order will be step s42. The initial replicating order needs to complete its trade and this is done when s37 notifies s42 of the successful trade of the linking CFD trade. This whole trade sequence begins with a CFD offer order. The synthesizing unit replicates this in the cash market with a cash offer. This equity offer is hit by an equity buyer. The synthesizing unit then must buy in the CFD market to create the hedge s36 and notify the equity link trade that the hedge was successful s42, so that the original trade can be released. The releasing only occurs on a common platform as a separate equity market would not allow the original cash trade to wait in pending for the CFD hedge to be verified.

The trade process is then executed (step s38). The synthesizing unit bid cannot be larger than the client offer as the synthesizing unit bid was generated from the CFD client offer in the first place, so there is no question as to the bid order remaining partially unfilled.

In example 2, the exchange determines that the CFD bid order originated from a client order (step s35), rather than the synthesizing unit 5 and the exchange then determines if the best offer quote is from the synthesizing unit 5 (step s39). In this example, 10,000 of the 25,000 ABC CFDs on offer at $50.01 are offered by CFD clients and 15,000 are offered by the synthesizing unit 5, replicating the 15,000 on offer by cash clients. The 10,000 CFD client orders are prioritized ahead of the synthesizing unit's order, though this is a flexible option such that orders could just be set on a price time priority. The first 10,000 ABC CFDs will trade in time priority against the 10,000 ABC CFDs offered by CFD clients and are held in a confirmation pending state (step s48).

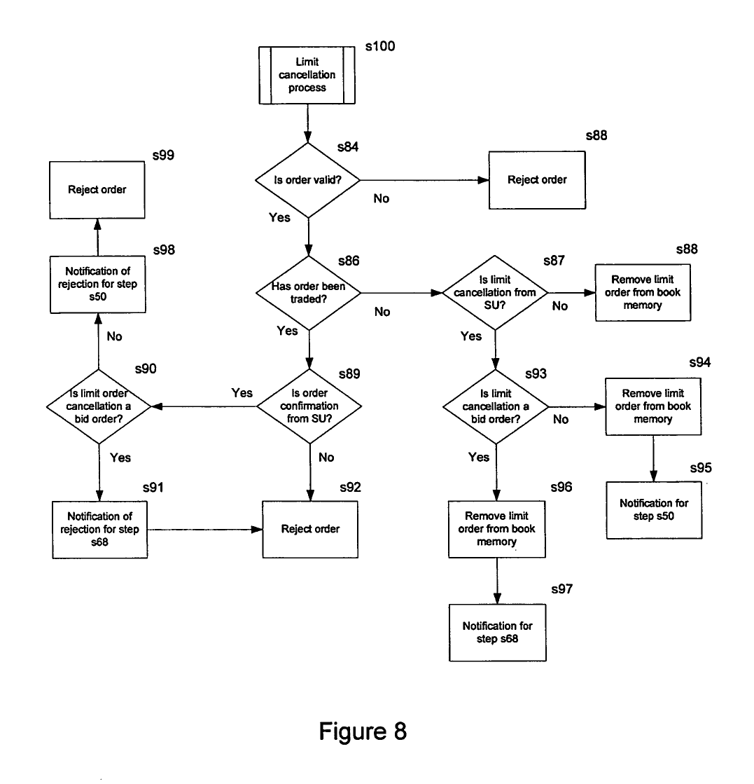

An order cancellation is then sent to the synthesizing unit for the CFD client offer of 10,000 ABC CFDs at $50.01 (step s49). The order cancellation is taken and entered through the limit cancellation process which cancels the replicating $50.01 10,000 stock offer in the underlying cash commodity market (step s100). The limit cancellation process is described in FIG. 8. When this stock offer order is successfully cancelled, which will be performed in real time in the limit cancellation process, the synthesizing unit 5 confirms its CFD cancellation (step s50). This cancellation confirmation ensures that the synthesizing unit 5 always maintains a matched position and doesn't trade one leg of a transaction that is not hedged fully. Now there is no replicating CFD offer in the underlying cash commodity market by the synthesizing unit at $50.01 and there remain 15,000 ABC stocks offered by cash clients. This is still replicated by the synthesizing unit 5 onto the CFD market. On receipt of confirmation of the cancellation of the replicated order from the synthesizing unit 5, the CFD exchange 6 trades the 10,000 CFDs at $50.01 (step s51) and the trade process is executed (step s52), where confirmation would be sent to the respective CFD members 8 and the trade would be time stamped, logged, published and sent through to the clearing house 9 for clearing.

If however the synthesizing unit 5 was not able to cancel the replicating cash order for 10,000 ABC stock at $50.01 in step s100 in the limit cancellation process, as all or part had been traded in the underlying cash commodity market at the same time, then the synthesizing unit 5 notifies the CFD exchange 6 (step s50) of the failure to cancel all or part of the replicating offer. The exchange then determines that full cancellation was not possible at the synthesizing unit 5 and the balance of the trade that reflects the amount of the offer order that could not be cancelled in the underlying cash commodity market is cancelled (step s46). As described above, the part of the trade for which confirmation was received is traded (steps s51, s52). For the portion of the trade that was cancelled (step s46), it is determined whether the order was a limit or market order (step s47). A limit order is sent back to the order processing stage for reprocessing (step s5 in FIG. 4b). If the order is a market order then the next best volume and price needs to be determined and it is routed back to restart the bid matching process at step s35.

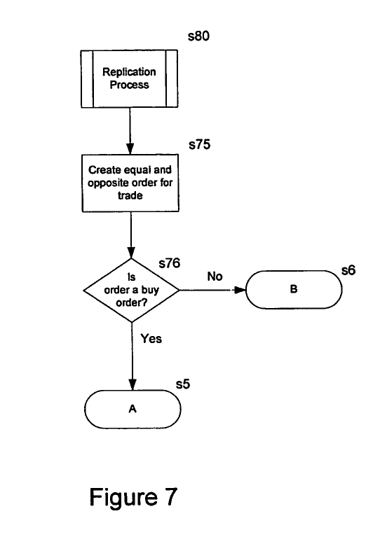

Assuming that all of the replication order was cancelled in the underlying cash commodity market by the synthesizing unit 5, thus allowing the first 10,000 of the CFD order to trade against CFD clients at $50.01, then there remains 20,000 still left in the bid at $50.01. The exchange determines that after the first 10,000, the remainder can trade against the synthesizing unit's offer at the same price (step s39). The synthesizing unit has 15,000 ABC CFDs on offer at $50.01 replicating 15,000 stocks on offer at $50.01 in the underlying cash commodity market. The 15,000 CFD trade is marked as pending (step s40) while a confirmation is sent to the synthesizing unit 5 (step s41). The trade confirmation is entered through the replication process (step s80), which trades the $50.01 15,000 ABC stock in the underlying cash commodity market. The replication process is described in FIG. 7. This creates the hedge for the synthesizing unit in the underlying cash commodity market by buying 15,000 cash stocks at $50.01 from cash clients. The synthesizing unit 5 confirms the amount traded to the CFD exchange 6, all of which occurs in real time. The amount that was confirmed (step s42) is in turn traded (step s43) and the exchange 6 determines whether the bid order was filled in full (step s44). Assuming the whole 15,000 was confirmed, the trade process is executed for the 15,000 CFDs at $50.01 (step s38). A total of 25,000 ABC CFDs have now been traded and confirmed, 10,000 with CFD clients and 15,000 with the synthesizing unit 5. In relation to the balance of 5,000 that remains of the original 30,000 bid, it is determined whether the original order was a market order or a limit order (step s45). A limit order is sent back to the order processing module for reprocessing (step s5). If the order is a market order then the next best volume and price needs to be determined and it is routed back to step s35, as described above. In example 2, the order was a limit order to buy 30,000 ABC CFDs at $50.01 and thus the market for ABC CFDs goes $50.01 bid for the remaining 5,000, and the order processing section will ensure that this order is in turn replicated onto the underlying cash commodity market via the synthesizing unit 5 (step s9) as a bid for 5,000 ABC stock at $50.01.

If the synthesizing unit could not effect the complete hedge into the underlying cash commodity market against the client offered stock at $50.01 (step s42), then the unhedged balance will be cancelled (step s46). The exchange then determines whether the original order was a market order or a limit order. A limit order is sent back to step s5 to be reprocessed. If the order is a market order then the next best volume and price needs to be determined and it is routed back to step s35, as described above.

FIG. 6b describes the offer matching process of the invention. This is the reverse of the process described in FIG. 6a and starts at step s32 where the offer matching trade for both limit and at market orders from both clients and the synthesizing unit enter the trading process. The offer matching process determines whether the offer originated from the synthesizing unit or a client (step s53). If the offer originated from the synthesizing unit then the trade moves straight into the trade process (step s54), where it is traded against member orders according to time priority. A confirmation is then generated (step s55) which is subsequently checked for at step s60, if the market is operating as a CFD and cash market on one platform 12, as the synthesizing unit offer had to originate from a replication order being traded to initiate this trade. The trade process is then executed (step s56). The synthesizing unit offer cannot be larger than the client offer as the synthesizing unit offer was generated from the client offer in the first place in the linked market so there is no question as to the offer order remaining partially unfilled.

If the offer order originated from a client (step s53), then the offer matching process determines whether the best bid originated from a client or the synthesizing unit (step s57). If the best bid also originated from a client then the trade is marked as pending (step s66). In this case, the offer matching process sends an order cancellation to the synthesizing unit for the client bid (step s67). The order cancellation is taken and entered through the limit cancellation process (step s100) which cancels the replicating bid in the linked market. When the bid order is successfully cancelled, which will be performed in real time in the replication process, the synthesizing unit confirms its bid cancellation. This cancellation ensures that the synthesizing unit always maintains a matched position and doesn't trade one leg of a transaction that is not hedged fully. Now there is no replicating linked bid in the linked market by the synthesizing unit. On receipt of the confirmation from the synthesizing unit (step s68), the client orders are traded (step s69) and the trade process executed (step s70), where confirmation would be sent to the respective CFD members 8 and the trade would be time stamped, logged, published and sent through to the clearing house 9 for clearing.

If however the synthesizing unit was not able to cancel the replicating order in the linked market in the limit cancellation process (step s100), as all or part had been traded in the linked market at the same time, then the synthesizing unit will notify the offer matching process (step s68). The offer matching process then determines that full cancellation was not possible at the synthesizing unit 5 (step s68) and the balance of the trade that reflects the amount of the bid order that could not be cancelled in the linked market will be cancelled (step s64). As described above, the part of the trade for which confirmation was received is traded (steps s69, s70). For the portion of the trade that was cancelled (step s64), it is determined whether the order was a limit or market order (step s65). A limit order is sent back to the order processing stage for reprocessing (step s6 in FIG. 4b). If the order is a market order then the next best volume and price needs to be determined and it is routed back to restart the offer matching process at step s53.

If the best bid quote was from the synthesizing unit (step s57), the trade is marked as pending (step s58), while a confirmation is sent to the synthesizing unit (step s59). The trade confirmation is entered through the replication process (step s80) and trades the replicating trade in the linked market. This creates the hedge for the synthesizing unit in the linked market by selling the replicating position to replicating clients which hedges the current matched buy transaction.

The synthesizing unit confirms the amount traded to the offer matching process, which all occurs in real time. The amount that was confirmed (step s60) is in turn traded (step s61) and the offer matching process determines whether the offer order was filled in full (step s62). The trade process is executed (step s56) for the amount that was matched with the synthesizing unit, while for the balance that remains, it is determined whether the original order was a market order or a limit order (step s63). A limit order is sent back to step s6 in the order processing module to be reprocessed. If the order is a market order then the next best volume and price needs to be determined and it is routed back to step s53.

If the synthesizing unit could not effect the complete hedge into the replicating market against the replicating client bid (step s60) then the unhedged balance is cancelled (step s64). It is then determined whether the original order was a market order or a limit order (step s65). As described above, a limit order is sent back to step s6 in the order processing module to be reprocessed and if the order is a market order then the next best volume and price needs to be determined and it is routed back to step s53.

FIG. 7 describes the replication process that links the CFD market with the underlying cash commodity market in both directions for hedging purposes. Step s80 is initiated by a trade in the bid or offer matching process that has occurred in either a CFD transaction or a transaction in the underlying cash commodity market. The replication process is designed to effect the hedge for the synthesizing unit 5.

An equal and opposite order is therefore created for the trade (step s75). All synthesizing unit trade hedges require an equal and opposite transaction to be generated that effectively links the two markets together and ensures the synthesizing unit maintains matched positions.

The replication process determines whether the equal and opposite order is a bid or offer order (step s76). Bid orders are routed back to step s5 and offer orders to step s6 in the order processing module.

For example, in example 2 above the second part of the transaction was against the synthesizing unit offer of 15,000 ABC CFDs at $50.01, which required a hedge in the underlying cash commodity market. Thus the synthesizing unit was notified (step s41) to effect the hedge by buying 15,000 ABC stock at $50.01. Steps s5 to s14 would then occur as described above to initiate the bid matching process for the underlying cash commodity market. In the bid matching process, the bid would be from the synthesizing unit (step s35), which would cause the trade between the cash client's offer and the synthesizing unit's buying hedge trade. Step s37 would confirm the hedge occurring in the underlying cash commodity market to step s42, as described earlier, thus causing the CFD trade to now proceed to active from pending.

FIG. 8 describes the limit cancellation process which removes the replication order that the synthesizing unit 5 places in the replication market whenever a client order matches another client order. The synthesizing unit's replication order must be cancelled before the client matched transaction can be released to ensure that the synthesizing unit does not trade a replication order that no longer has the original client leg from which it was generated.

The cancellation order enters the cancellation process (step s100) from which it is determined whether the cancellation order is valid (step s84). Non valid cancellation orders are rejected (step s85), while valid cancellation orders are tested to determine whether the order has been traded or not (step s86). Orders that have not been traded and are still on the order book are then checked to determine whether the order is from a synthesizing unit or not (step s87). Cancellation orders from clients are removed from the order book (step s88), while synthesizing unit cancellation orders are checked (step s93) to determine whether they are bid or offer orders. Offer orders are removed from the order book (step s94) and this information is passed onto the bid matching process via step s50. In example 2 above the original 10,000 ABC CFDs that the CFD client bought from other CFD clients at $50.01 required the synthesizing unit to cancel the replicating order to sell 10,000 ABC stock at $50.01 in the underlying cash commodity market. Once the synthesizing unit has cancelled this replicating order in the cash market it will inform the matching engine at step s50 (step s95) to allow the client matched trade to proceed. If the order is a bid order the order is removed from the order book (step s96) and this information is passed onto the offer matching process at step s68 (step s97).

If the order has already been traded (step s86) then the limit cancellation process determines whether the order was from the synthesizing unit (step s89). Client orders are rejected (step s92), while it is determined whether synthesizing unit orders are bid or offer orders (step s90). Bid orders are processed by sending a notification of rejection to the offer matching process at step s68 (step s91). The cancellation order is then cancelled (step s92). Offer orders are processed by sending a notification of rejection to the bid matching process at step s50 (step s98). The cancellation order is then cancelled (step s99).

It will be apparent to the skilled person that changes may be made in the construction and the operation of the various components, elements and processes described herein and changes may be made in the steps or the sequence of steps of the methods described herein without departing from the spirit and scope of the invention as defined in the claims.

1. A system for trading derivative financial instruments, each of which corresponds to an underlying financial instrument from which it is derived, the underlying instrument being traded on an underlying exchange, the system comprising:
a derivative exchange for receiving orders for the derivative instruments; and
a synthesizing unit for automatically placing corresponding orders for the underlying instruments on the underlying exchange.

2. The system of claim 1, wherein the synthesizing unit is arranged to receive orders for underlying financial instruments from the underlying exchange and to place corresponding orders for the derivative instruments on the derivative exchange.

3. The system of claim 1, wherein the underlying exchange and the derivative exchange are hosted on the same platform.

4. The system of claim 1, wherein the underlying exchange and the derivative exchange are hosted on different platforms.

5. The system of claim 1, wherein the synthesizing unit is for linking the derivative exchange and the underlying exchange.

6. The system of claim 1, wherein the derivative financial instruments comprise Contracts for Difference (CFDs).

7. The system of claim 1, wherein the underlying financial instruments comprise equities.

8. The system of claim 1, wherein the underlying financial instruments comprise commodities.

9. The system of claim 1, wherein the underlying financial instruments comprise bonds.

10. The system of claim 1, wherein the underlying financial instruments comprise foreign exchange instruments.

11. The system of claim 1, wherein the underlying financial instruments comprise financial indices.

12. A system for trading derivative financial instruments, each of which corresponds to an underlying financial instrument from which it is derived, the system comprising:
a derivative exchange for receiving orders for the derivative instruments;
an underlying exchange for receiving orders for the underlying instruments; and
a synthesizing unit linked to the derivative exchange and the underlying exchange, for replicating orders on the derivative exchange onto the underlying exchange and for replicating orders on the underlying exchange onto the derivative exchange.

13. The system of claim 12, wherein the derivative exchange and the underlying exchange are provided on a single exchange.

14. The system of claim 12, wherein the derivative financial instruments are Contracts for Difference (CFDs).

15. The system of claim 12, wherein the orders comprise bid orders.

16. The system of claim 12, wherein the orders comprise offer orders.

17. The system of claim 12, comprising a processing module for executing a trade process, the processing module being arranged to trade an order from a client against an order from the synthesizing unit.

18. The system of claim 17, wherein the processing module is arranged to cancel a replicated order on one of the derivative and underlying exchanges when executing a trade involving two entities from the other of the derivative and underlying exchanges.

19. The system of claim 12, wherein the synthesizing unit is configured to restrict replication of orders and transactions into and from the underlying exchange in the event that an imbalance arises between the derivative exchange and the underlying exchange.

20. The system of claim 19, comprising restricting said replication of orders and transactions to selected types of orders and transactions, said types being selected from limited long, long only, limited short and short only.

21. The system of claim 19, wherein said restriction comprises disengagement of the link between the derivative exchange and the underlying exchange.

22. A system for linking a derivative market and an underlying market, the derivative market for trading derivative financial instruments, and the underlying market for trading underlying financial instruments from which said derivative instruments are derived, the system comprising:
a synthesizing unit for receiving orders from at least one of said derivative and underlying markets and for generating equal and opposite orders on at least the other of said markets to enable members of said at least one of said markets to trade with members on said at least the other of said markets.

23. The system of claim 22, wherein the synthesizing unit is configured to permit members of the same market to trade with one another.

24. The system of claim 22, wherein the synthesizing unit is configured to permit members of each of said markets to trade with the synthesizing unit.

25. The system of claim 22, configured to permit prioritization of members' orders over synthesizing unit orders.

26. The system of claim 22, wherein the derivative instruments comprise Contracts for Difference (CFDs).

27. A method for trading derivative financial instruments on a derivative exchange, each of the derivative instruments corresponding to an underlying financial instrument from which it is derived, the underlying instrument being traded on an underlying exchange, the method comprising:
receiving orders for the derivative instruments;
receiving orders for the underlying instruments; and
replicating orders on the derivative exchange onto the underlying exchange and replicating orders on the underlying exchange onto the derivative exchange.

28. The method of claim 27, wherein the derivative instruments comprise Contracts for Difference (CFDs).

29. The method of claim 27, wherein the derivative instruments and the underlying instruments are listed on the same exchange.

30. The method of claim 27, wherein the derivative instruments and the underlying instruments are listed separately on said derivative exchange and said underlying exchange.
